(19) United States
(12) Patent Application Publication
(10) Pub. No.: US 2022/0019436 A1
(43) Pub. Date: Jan. 20, 2022

(54) FUSION OF MICROPROCESSOR STORE INSTRUCTIONS

(71) Applicant: International Business Machines Corporation, Armonk, NY (US)

(72) Inventors: Bryan Lloyd, Austin, TX (US); Sundeep Chadha, Austin, TX (US); Dung Q. Nguyen, Austin, TX (US); Christian Gerhard Zoellin, Austin, TX (US); Brian W. Thompto, Austin, TX (US); Sheldon Bernard Levenstein, Austin, TX (US); Phillip G. Williams, Cape Coral, FL (US); Robert A. Cordes, Austin, TX (US); Brian Chen, Austin, TX (US)

(21) Appl. No.: 16/933,241

(22) Filed: Jul. 20, 2020

(51) Int. Cl. G06F 9/30; G06F 9/38

(52) U.S. Cl. CPC G06F 9/30079; G06F 9/30047; G06F 9/3814; G06F 9/3867; G06F 9/30043

(57) ABSTRACT

Provided is a method for fusing store instructions in a microprocessor. The method includes identifying two instructions in an execution pipeline of a microprocessor. The method further includes determining that the two instructions meet a fusion criteria. In response to determining that the two instructions meet the fusion criteria, the two instructions are recoded into a fused instruction. The fused instruction is executed.

### BACKGROUND

The present disclosure relates generally to the field of computing, and more particularly to fusing instructions in a microprocessor.

A microprocessor is a computer processor that incorporates the functions of a central processing unit on one or more integrated circuits (ICs). Processors execute instructions (e.g., store instructions) based on a clock cycle. A clock cycle, or simply “cycle,” is a single electronic pulse of the processor. Typically, a processor is able to execute a single instruction per cycle.

### SUMMARY

Embodiments of the present disclosure include a method, computer program product, and system for fusing store instructions in a microprocessor. The method includes identifying two instructions in an execution pipeline of a microprocessor. The method further includes determining that the two instructions meet a fusion criteria. In response to determining that the two instructions meet the fusion criteria, the two instructions are recoded into a fused instruction. The fused instruction is executed.

Embodiments further include a microprocessor configured to fuse instructions. The microprocessor includes an instruction fetch unit, an instruction sequencing unit, and a load-store unit. The instruction fetch unit is configured to determine that two store instructions fetched from memory are fuseable. The instruction fetch unit is further configured to recode the two store instructions into a fused store instruction. The instruction sequencing unit is configured to receive the fused store instruction from the instruction fetch unit and store the fused instruction as an entry in an issue queue. A first half of the fused store instruction is stored in a first half of the issue queue, and a second half of the fused store instruction is stored in a second half of the issue queue. The load-store unit is configured to receive the fused store instruction from the issue queue, generate a store address using the first half of the fused store instruction, store the store address in a store reorder queue, and store data from the second half of the fused store instruction in a store data queue.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a high level block diagram of various components of an example processor microarchitecture, in accordance with embodiments of the present disclosure.

FIG. 2 illustrates a block diagram of an example microarchitecture of a processor configured to fuse instructions, in accordance with embodiments of the present disclosure.

FIG. 3A illustrates a block diagram of the example instruction fetch unit (IFU) of FIG. 2, in accordance with embodiments of the present disclosure.

FIG. 3B illustrates a block diagram of the example instruction sequencing unit (ISU) of FIG. 2, in accordance with embodiments of the present disclosure.

FIG. 3C illustrates a block diagram of the example vector/scalar unit (VSU) and the example load-store unit (LSU) of FIG. 2, in accordance with embodiments of the present disclosure.

FIG. 3D illustrates a block diagram of the completion and exception handling of FIG. 2, in accordance with embodiments of the present disclosure.

FIG. 4 illustrates a flowchart of an example method for fusing instructions be executed by a microprocessor, in accordance with embodiments of the present disclosure.

FIG. 5 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to the field of computing, and in particular to fusing store instructions in a microprocessor. While the present disclosure is not necessarily limited to such applications, various aspects of the disclosure may be appreciated through a discussion of various examples using this context.

Currently, store instructions executed within a microprocessor core or thread are handled individually (i.e., one at a time). As such, a single load-store instruction is able to issue with each clock cycle, limiting the execution bandwidth of the processor. Adding more cores or hardware threads can overcome increase the performance, but each core/hardware thread takes up considerable space on the processor die.

Embodiments of the present disclosure are designed to improve execution bandwidth with moderate impact on the size of the components, thereby increasing the performance of the microprocessor. Embodiments of the present disclosure include examining the execution streams up front (e.g., during instruction fetching) and identifying instructions (e.g., store instructions) that can be fused and executed together. These instructions, referred to as “fuseable instructions” herein, are then recoded into a new instruction with a new iop (instruction opcode), referred to herein as a “fused instruction.” The fused instruction look like a single instruction to do both stores atomically. The fused instruction can be buffered into the execution stream and executed as a single instruction, requiring only a single clock cycle to complete both instructions.

In some embodiments, instructions are analyzed when the instruction fetch unit (IFU) fetches them from L2 cache to see if they can be fused. The IFU uses a set of fusion criteria to determine whether the instruction can be fused. For example, the IFU may looks for two store instructions accessing adjacent memory as they come into the core. This may be performed by hardware logic before the instructions are placed in the instruction cache (Icache). In some embodiments, the IFU may get rid of unnecessary bits (e.g., drops 32 bit instruction to 20 bits, keeping type (load/store) and size) when recoding/fusing the instructions.

In some embodiments, the instructions may have to be consecutive in order to be fused. However, in other embodiments, the fuseable instructions could have one or more instructions in between them, provided that it was not a branch instruction in the middle. Additionally, in some embodiments, fusion requires that the instructions have the same base register, have the same size, and that the offset be a particular size. For example, if the store instructions are both 8-bit stores, the offsets must have a difference of 8-bits (assuming the instructions have the same base register) to ensure that they are being written to contiguous memory locations.

Embodiments of the present disclosure support both ascending and descending store fusions. For example, for 8-bit stores, the instructions can be displaced by x+0 from the base register and x+8 from the base register, respectively, or reversed x+8 and x+0, respectively. In other words, as long as both instructions are to write to adjacent memory areas (e.g., evidences by the difference between their offsets being equal to the store size), it does not matter which order they are fetched in. If they are fetched such that the second instruction is written to the first memory location (i.e., the memory location directly before the first instruction), the system can “flip” the order of the instructions after fusion. In these embodiments, the issue queue (ISQ) is told to swap instructions before transmitting them to the load-store unit (LSU). The determination of whether the instructions need to be flipped, and whether they are fuseable, is part of pre-decode, and a bit marks whether there is a swap. Accordingly, in some embodiments, there are two bits used as flags: the first bit says whether the instructions are to be fused, and the second bit says whether to swap their order. These bit can override existing bits for existing iops. In any case, the instructions will still be loaded in the proper order for atomic execution.

Embodiments of the present disclosure can support fusion of numerous store sizes, dependent only upon the architecture of the processor. For example, some embodiments may be configured to fuse stores include single bits, half words, single words (SW), double words (DW), and quad words (QW). Depending on the size of the queues, the buses, and the stores, additional handling may be required for larger stores. For example, if a store queue is 16 bytes wide, it may be able to handle fusion of two double words into a 16 byte store using a single issue and single STAG (as discussed herein). However, fusion of two quad words into a 32 byte store may requiring that the instruction issues twice and writes two consecutive STAGs.

While embodiments of the present disclosure are described herein using a 16 byte (128 bit) store queue, it is to be understood that this is done for illustrative purposes. As would be recognized by a person of ordinary skill, the embodiments described herein can be adapted to other size store queues, and the present disclosure is not to be limited to 16 byte store queues.

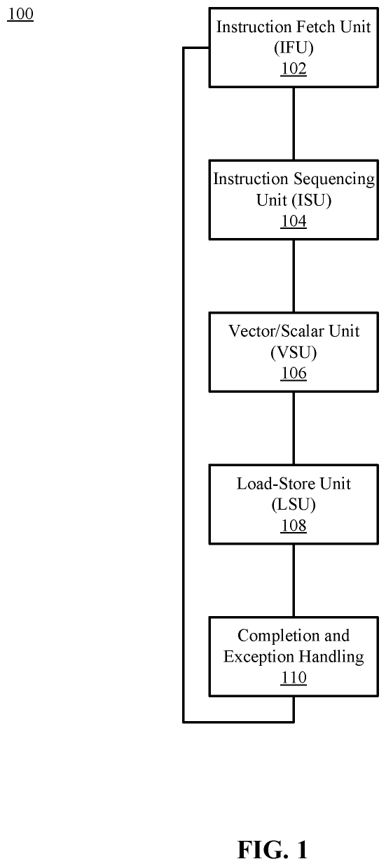

Turning now to the figures, FIG. 1 illustrates a high level block diagram of various components of an example microprocessor 100, in accordance with embodiments of the present disclosure. The microprocessor 100 includes an instruction fetch unit (IFU) 102, an instruction sequencing unit (ISU) 104, a load-store unit (LSU) 108, a vector/scalar unit (VSU) 106, and completion and exception handling logic 110.

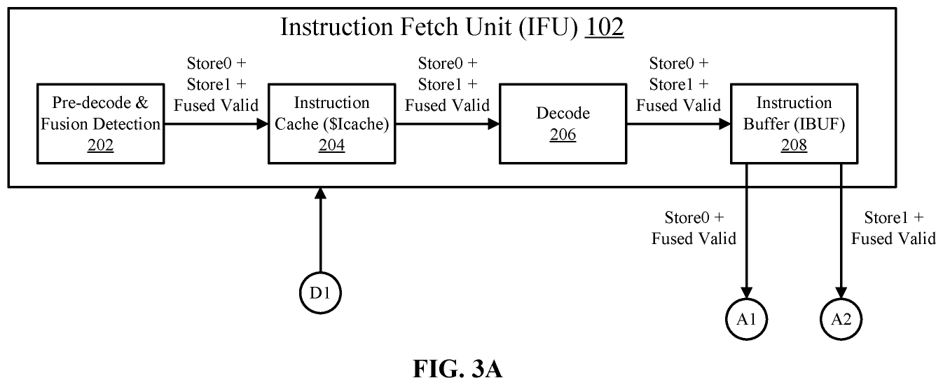

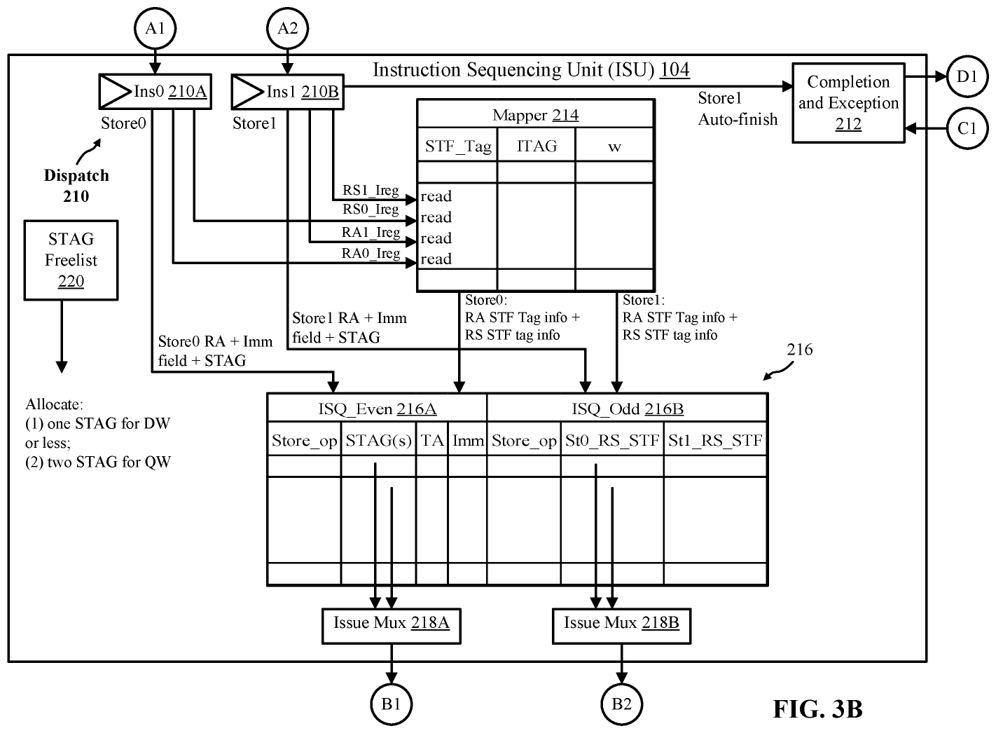

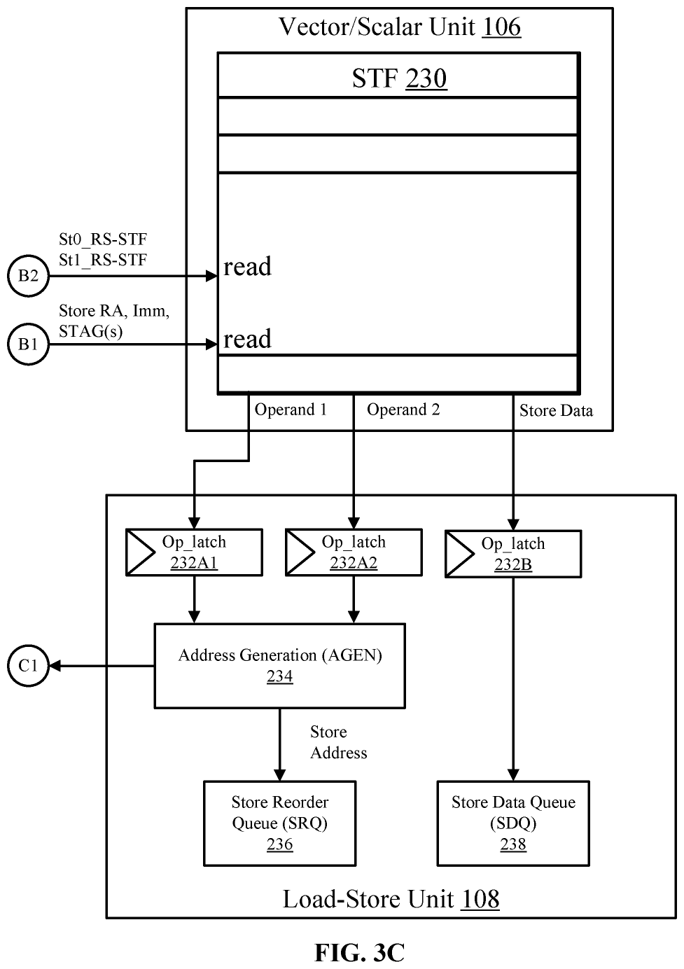

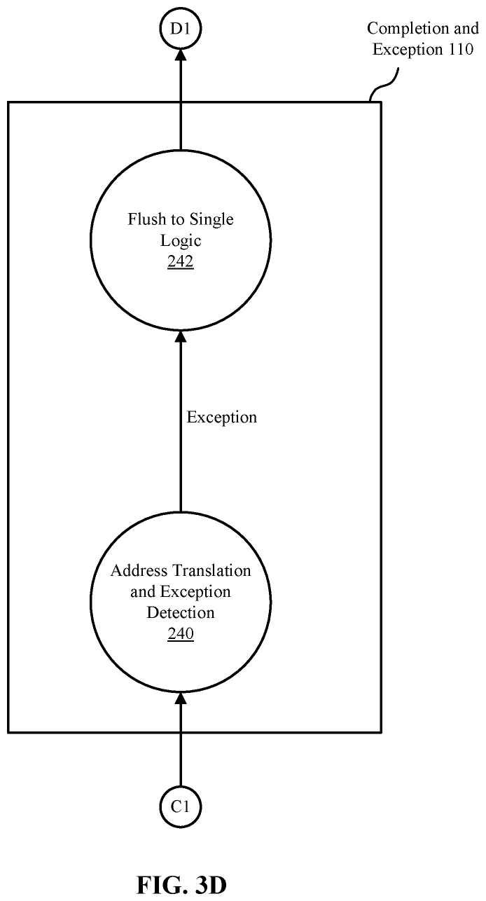

The IFU 102 is a processing unit responsible for organizing program instructions to be fetched from memory, and executed, in an appropriate order. IFU 102 is often considered to be part of the control unit (e.g., the unit responsible for directing operation of the processor) of a central processing unit (CPU). A more detailed example of the IFU 102 is discussed with respect to FIG. 3A.

The ISU 104 is a computing unit responsible for dispatching instructions to issue queues, renaming registers to support out-of-order execution, issues instructions from issue queues to execution pipelines, completes executing instructions, and handles exceptions. The ISU 104 includes an issue queue that issues all of the instructions once the dependencies are resolved. A more detailed example of the ISU 104 is discussed with respect to FIG. 3B.

The VSU 106 is a computing unit that maintains ownership of a slice target file (STF). The STF holds the registers needed for the store address operands and the store data that is sent to the LSU 108 for execution.

The LSU 108 is an execution unit responsible for executing all load and store instructions, managing the interface of the core of the processor with the rest of the systems using a unified cache, and performing address translation. For example, the LSU 108 generates virtual addresses of load and store operations, and it loads data from memory (for a load operations), or stores data to the memory from registers (for a store operation). The LSU 108 may include a queue for memory instructions, and the LSU 108 may operate independently from the other units. A more detailed example of the LSU 108 is discussed with respect to FIG. 3C.

The completion and exception handling logic 110 (hereinafter “completion logic” 110) is responsible for completing both parts (e.g., both instructions) of the fused store instruction at the same time. If the fused store instruction causes an exception, the completion logic 110 flushes both parts of the fused instruction and signals to the IFU to re-fetch the fused instruction as two separate instructions (i.e., without fusion). A more detailed example of the completion logic 110 is discussed with respect to FIG. 3D.

It is to be understood that the components 102-110 shown in FIG. 1 are provided for illustrative purposes and to explain the principles of the embodiments of the present disclosure. Some processor architectures may include more, fewer, or different components, and the various functions of the components 102-110 may be performed by different components in some embodiments. For example, the exception and completion handling may be performed by the ISU 104.

Additionally, processors may include more than one of the components 102-110. For example, a multi-core processor may include one or more instruction fetch units (IFUs) 102 per core. Furthermore, while the embodiments of the present disclosure are generally discussed with reference to POWER® processors, this is done for illustrative purposes. The present disclosure may be implemented by other processor architectures, the disclosure is not to be limited to POWER processors.

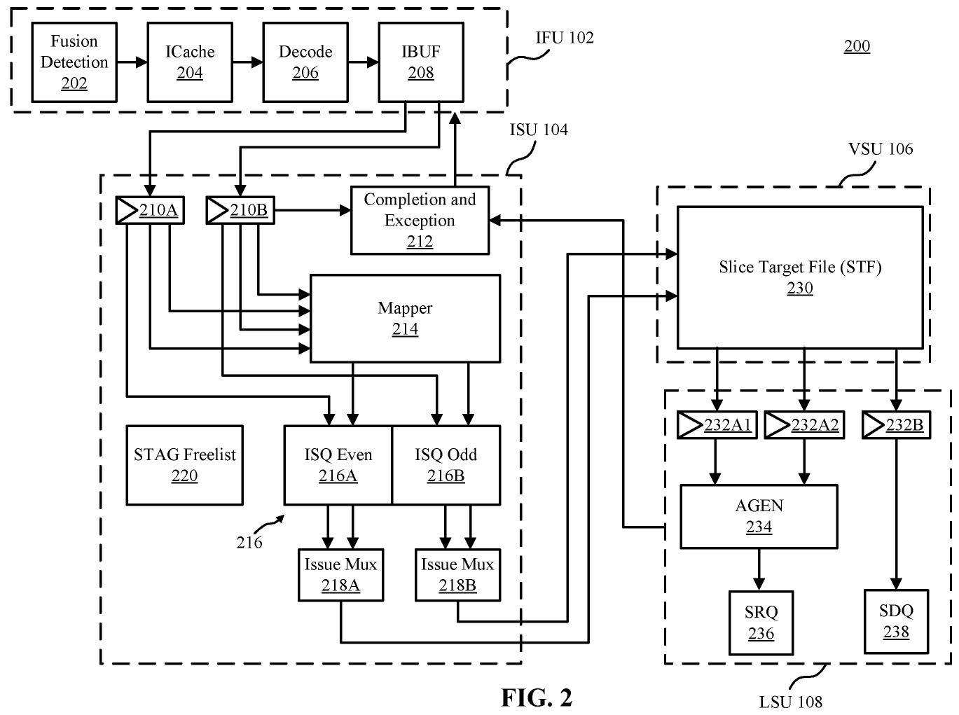

Referring now to FIG. 2, illustrated is a block diagram of an example microprocessor 200 configured to fuse instructions, in accordance with embodiments of the present disclosure. The microprocessor 200 includes an IFU 102, an ISU 104, a VSU 106, and an LSU 108. The IFU, ISU, VSU, and LSU may be substantially similar to the IFU 102, ISU 104, VSU 106, and LSU 108 discussed with respect to FIG. 1.

FIG. 2 illustrates how the IFU 102, ISU 104, VSU 106, and LSU 108 are connected to each other, as well as the various subcomponents thereof, which are discussed in more detail in FIGS. 3A-3D. For example, as shown in FIG. 2, the IFU 102 includes a fusion detection logic 202, an Icache 204, decode logic 206, and an instruction buffer (IBUF) 208. A pair of lanes connected the IFU 102 (specifically through the IBUF 208) to the ISU 104 (specifically to dispatch lanes 210A and 210B, collectively referred to as dispatch 210).

The ISU 104 includes the dispatch 210, completion logic 212, a mapper 214, an issue queue (ISQ) 216, a pair of issue multiplexers (muxes) 218A, 218B, and a STAG freelist 220. The dispatch 210 includes two dispatch lanes 210A and 210B. Similarly, the ISQ 216 includes an even half 216A and an odd half 216B. Each of the issue muxes 218A, 218B is connected to one of the ISQ 216 halves. For example, the first issue mux 218A is connected to the ISQ even half 216A, and the second issue mux 218B is connected to the ISQ odd half 216B. Output from the two muxes 218A, 218B are sent to the VSU 106 (specifically, to the slice target file (STF) 230).

The VSU 106 includes the STF 230, which is a register file that holds the registers needed for the store address operands and the store data that is sent to the LSU 108 for execution. The VSU 106 receives data output from the muxes 218A, 218B of the ISU 104, and it outputs data to the LSU 108.

The LSU 108 includes a set of op latches 232A1, 232A2, 232B, an address generator (AGEN) 234, a store reorder queue (SRQ) 236, and a store data queue (SDQ) 238. The LSU 108 is connected to the ISU 104 via completion and exception logic 212.

Referring now to FIG. 3A, illustrated is a block diagram of the example instruction fetch unit (IFU) of FIG. 2, in accordance with embodiments of the present disclosure. As discussed above with respect to FIG. 2, the IFU 102 comprises multiple subcomponents. Specifically, the example IFU 102 includes a pre-code and fusion detection logic 202, an instruction cache (Icache) 204, decoder logic 206, and an instruction buffer (IBUF) 208

In embodiments of the present disclosure, the pre-decode and fusion detection logic 202 determines whether two (or more) instructions are fuseable (e.g., satisfying fusion criteria for the microprocessor 100). This may be done when the IFU 102 is fetching the instruction from cache (e.g., L2 cache). The pre-decode and fusion detection logic 202 inspects the fetched instructions and uses a set of fusion criteria to determine whether two (or more) instructions are fuseable.

In some embodiments, the set of fusion criteria considers one or more of whether the instructions are near each other in the fetch queue (e.g., consecutive instructions, only 1 instruction between them, etc.), the instructions have the same base register, the offset of the instructions, and the type of instruction (e.g., D-form store vs. X-form store). For example, in some implementations, the pre-decode and fusion detection logic 202 may be configured to determine that a pair of instructions are fuseable if (1) they are both d-form store instructions, (2) they are consecutive instructions, (3) they have the same length (e.g., byte, half word, single word, double word, quad word), and (4) they are contiguous in memory (e.g., based on their immediate fields being consecutive). The type and length of the instructions may be determined from the RA fields of the instructions. Instructions not meeting all four criteria may not be fuseable in these implementations.

In other implementations, the set of fusion criteria may require more or less strict conditions in order to be fuseable. For example, some implementations may permit fusion of X-form store instructions by analyzing the registers of each instruction. Similarly, some implementations may permit fusing instructions that are not consecutive (i.e., at least one instructions is between them), such as if the instruction are within two instruction of each other. For example, the IFU 102 may include logic that compares each instruction to its following (and/or preceding) instruction as well as the next following (or next preceding) instruction. In some implementations, instructions that are contiguous but out of order can be fused.

There are two main types of store instructions: D-form stores and X-form stores. For D-form stores, the store address is formulated by a base-register plus a 16 bit immediate offset from the instruction itself. For X-form stores, the store address is made by reading two registers and adding them together. Because D-form stores just require knowledge of the base register and the offset, it is relatively simple to determine whether instructions are writing to consecutive areas of memory. Meanwhile, for X-form stores, it might be difficult to detect from instruction itself if the stores can be fused. For example, the processor might notice that one of the registers is the same, but the other register might not be. As such, in some embodiments, only D-form stores are supported, while other embodiments may support fusing X-form stores.

After determining that the instructions are fuseable, the pre-decode and fusion detection logic 202 recodes the fuseable instructions into a new instruction, referred to herein as a fused instruction, marks the fused instruction, and writes the fused instruction into the instruction cache (Icache) 204. The pre-decode and fusion detection logic 202 identifies whether the instruction being written to the Icache 204 is a fused instruction by setting a one-bit flag. For example, the pre-decode and fusion detection logic 202 may set a specified bit to 1 when the instruction is a fused instruction and to 0 when the instructions are not fused instructions.

After the pre-decode and fusion detection logic 202 writes the fused instruction to the Icache 204, the decode logic 206 may retrieve the fused instruction, decode it, and store the fused instruction in the IBUF 208. The IFU 102 may then transmit the fused instruction from the IBUF 208 to the ISU 104 using a lane pair. The first half of the fused instruction (Store0) may be transmitted to the ISU 104 on a first lane (i.e., go to A1 in FIG. 3B), and the second half of the fused instruction (Store1) may be transmitted to the ISU 104 on a second lane (i.e., go to A2 in FIG. 3B). Additionally, an indication that the Store0 and Store1 are halves of a fused store instruction are sent to the ISU 104.

In embodiments that enable fusion of out of order instructions, the pre-decode and fusion detection logic 202 may also set a second bit for the fused instruction. The second bit indicates that the two halves of the fused instruction are reversed (i.e., the second half modifies a first memory location and the first half modifies the following memory location). In other words, some embodiments support ascending and descending store fusions.

Referring now to FIG. 3B, illustrated is a block diagram of the example instruction sequencing unit (ISU) 104 of FIG. 2, in accordance with embodiments of the present disclosure. In embodiments of the present disclosure, the ISU 104 includes a dispatch 210. The dispatch is configured to transmit a fused instruction (e.g., a fused store) to a mapper 214, the issue queues 216, and the completion logic 212 on a pair lane. The fused instruction will take two dispatch slots 210A, 210B.

The mapper 214 stores the register tags (e.g., the STF tags) for the fused instruction, which is received from the dispatch 210. The STF tags identify the registers identified by the instructions that make up the fused instruction. The mapper may also store the instruction tags (ITAGs) for the instructions.

The dispatch 210 is also configured to assign STAGs to the fused instruction. The STAG(s) are fields that indicate the physical location in a store queue entry to which to write the instructions, and they are assigned from the dispatcher of the ISU 104 using a STAG freelist 220. The STAG freelist 220 includes a list of available STAGs that the dispatch 210 can assign to instructions. If the fused instruction comprises two single word (SW) or double word (DW) instructions, the dispatch only assigns one STAG to the fused instruction. If the fused instruction comprises two quad word (QW) instructions, two STAGs are assigned to the fused instruction.

The completion logic 212 is configured to write the instruction tags (ITAGs) for both instructions that made up the fused instruction into the completion table. The completion logic 212 also marks the two instructions as being atomic, meaning that they both must be completed together. The completion logic also auto-finishes the second half of the fused store instruction.

The fused instruction is then written into the ISQ 216. In some embodiments, the dispatch 210 sends the base register index (RA), immediate offset (Imm field), and the STAG(s) for the two halves of the fused instruction (Store0 and Store1) to the ISQ 216. The dispatch 210 may also send an indication that Store0 and Store1 are halves of a fused store instruction, as well as whether the ISQ needs to reverse the order of the stores (e.g., if they are contiguous, but in reverse order). Additionally, the mapper 214 sends the RS and RA STF Tag information for Store0 and Store1 to the ISQ 216.

Normally, store instructions are written to a single half of the ISQ 216. For example, an unfused instruction would be written as an entry in either the ISQ even half 216A or the ISQ odd half 216B, but not both. However, fused instructions are stored as a full ISQ entry (e.g., an entry spanning bother the even 216A and odd 216B halves of the ISQ). As such, the information regarding the first half of the fused instruction (Store0) is sent to the even lane 216A of the ISQ 216, while the information for Store1 is send to the odd lane 216B of the ISQ 216.

The fused instruction's data parts will wait in the ISQ 216 until both store data are available before issuing. For a fused instruction that stores a DW or less, the ISQ 216 will perform a single issue with two sources for the store data. For a store QW fused instruction, the ISQ 216 will issue store data twice: once for each of the two STF Tags that source the fused store data.

In other words, because the fused store requires reading from two different registers for the two pieces of store data that are going to be fused in the SDQ 238, the ISQ 216 waits for both to be ready before trying to issue the store data. For instance, if the two store data operands are sourced by two prior loads, the ISQ 216 waits until both loads write back to the STF 230 before issuing the store data(s). As an example, if the total fused width is 16 bytes or less, then this will occur with one store data issue on the 16 byte store data bus. If the total fused width is 32 bytes, there will be two issues on the 16 byte store data bus that will write two consecutive STAG entries, with each entry being 16 bytes wide in the SDQ 238.

When both store data are available, the data from the ISQ 216 will be muxed by the issue muxes 218A, 218B, and the output will be sent to the VSU 106, which will process the data and send information to the LSU 108 for execution. In the embodiment shown in FIGS. 3A-3D, the store address generation (AGEN) will issue from the even lane 216A, and the store data will issue from the odd lane 216B.

Referring now to FIG. 3C, illustrated is a block diagram of the example vector/scalar unit (VSU) 106 and the example load-store unit (LSU) 108 of FIG. 2, in accordance with embodiments of the present disclosure. The VSU 106 includes a slice target file (STF) 230, and the LSU 108 includes a set of operation latches 232A1, 232A2, 232B, an address generator (AGEN) 234, a store reorder queue (SRQ) 236, and a store data queue (SDQ) 238.

The STF 230 is the register file that is used for architected registers. While the main architected registers are general purpose registers (GPRs), vector\scalar registers (VSRs), and floating point registers (FPRs), all architected registers may be included in the STF 230. Arithmetic ops read the STF 230, internally execute in the VSU 106 using the data read from the STF 230, and then write back to the VSU 106. For LSU 108 store ops, the STF 230 is read from, and the address operands and data operand(s) are sent to the LSU 108 for execution.

The STF 230 receives the RS-STF tags for Store0 and Store1, as well as the Store RAs, Imm offsets, and STAG(s) from the ISU 104. The VSU 106 sends two address operands into two operand latches 232A1, 232A2 of the LSU 108. For store fusion cases, limited to D-form stores, the first operand (OpA) is the base register read from the STF 230, and the second (OpB) is the immediate offset. As shown in FIG. 3C, the first operand may be sent to a first operand latch 232A1 of the LSU 108, while the second operand may be sent to the second operand latch 232A2 of the LSU 108.

Using the received information (e.g., the base register and the immediate offset), the LSU 108 generates the proper store address using the AGEN 234. The store address generated by AGEN 234 is then sent to the SRQ 236 using the STAG as the write address. Assuming a 128 bit width, for a store DW or less, the fused store consumes a single SRQ entry. Similarly, for a store QW, the fused store consumes two SRQ entries.

The store data will have 2 sources (SRC), meaning 2 STF 230 register entries that it reads from to get the overall fused store data that it will issue. The fused store data sends one SRC on a first half of the available bits, and the second SRC on the second half of the available bits. For example, assuming again a 128 bit bandwidth bus and a DW or less store, the first SRC is second on bits [0:63], and the second SRC is sent on bit [64:127]. Both halves of the store data bus are independently formatted to form one consecutive block of data. In this example, all of the store data is sent on the data bus in the same cycle. For a QW store, the data is sent in two cycles. The store data is written into the SDQ 238 using the STAG as the address pointer. For a store DW or less, the fused store will consume one SDQ 238 entry. For a store QW, the fused store will consume two SDQ 238 entries.

The SDQ 238 goes to L1 or L2 cache. However, the data has to be shifted in unique way before it can be stored, depending on the size of the store queue and the size of the instructions. This is because the data may not be back to back on the bus due to how the data is read from the registers and/or due to padding. The data is read from separate registers: one instruction uses lower half of the bus, and the other instruction uses upper half. For SW into store DW, the system wants to do an 8 byte store to two memory locations. However, because the bus is 16 bytes wide, and each instruction used half of its allocated space (e.g., each instruction used four of its 8 bytes), the processor first has to shift first four bytes to be adjacent to second four bytes before going into the store data queue.

Similarly, it is a little different when you fuse quad word stores than double word stores with the 16 byte store data bus. When it is less than a QW fused store, there is only one store data issue, with one instruction sent on bits 0-63, and the other instruction sent on bit 64-127. With DW fused store, bits 0-63 are used for both instructions (0-31 for the first instruction and 32-63 for the second instruction). With a SW fused store, only bits 0-31 are used (0-15 for the first instruction, 16-31 for the second instruction).

For cache inhibited stores (or for an LSU 108 exception), the LSU 108 will signal the IFU 102 (via the ISU 104) to perform a flush to single to break the fused store instruction into two separate store instructions. The two separate instructions will then be treated like normal instructions.

Referring now to FIG. 3D, illustrated is a block diagram of the completion and exception handling logic of FIG. 2, in accordance with embodiments of the present disclosure. The completion and handling logic may be part of the completion and exception logic 212 of the ISU 104.

If the LSU 108 detects an exception, it will signal to the ISU 104 completion and exception logic 212 that an exception was detected. The ISU 104 completion and exception logic 212 then signals to the IFU 102 that the fused store should be flushed and broken apart. The IFU 102 then handles the broadcast of the flush to the core, as well as tracking that the original store instructions should not fuse.

Completion logic 240 will complete both halves of the fused store instruction at the same time, provided that there is no identified exception. If an exception is caused by the fused store instruction, then the completion logic 240 will flush both halves of the fused store instruction 242. It will then signal the IFU 102 to re-fetch the fused store instruction as two separate Store instructions (i.e., without fusing them). The store instructions will resume execution from the first half of the original fused store instruction. The exception will be taken on the appropriate half of the original store fused instruction.

For example, if two stores that are fused together cross a translation page (e.g., the first store was in a first page and the second store was in a second page), the exception detection logic may indicate that there is an exception. The system can get an issue where one store does not want to record an exception, but the other does (e.g., because it crosses page boundary). In these situations, the system needs to record exception on the correct store/address. This will cause the two instructions to be re-fetched and treated as unfuseable instructions.

Fusion may also be disables after a non-branch flush. The fusion may be disabled for the first pair of instructions fetched, for more than 2 instructions, or for the entire first fetch, depending on the implementation.

It is to be understood that the components and subcomponents 102-242 shown in FIGS. 2-3D are provided for illustrative purposes and to explain the principles of the embodiments of the present disclosure. Some processor architectures may include more, fewer, or different components, including more, fewer, or different subcomponents, and the various functions of the components and subcomponent 102-242 may be performed by different components in some embodiments. Additionally, processors may include more than one of the components 102-242, and the components may be arranged in a different order. For example, a multi-core processor may include one or more instruction fetch units (IFUs) 102 per core. Furthermore, while the embodiments of the present disclosure are generally discussed with reference to POWER® processors, this is done for illustrative purposes. The present disclosure may be implemented by other processor architectures, the disclosure is not to be limited to POWER processors.

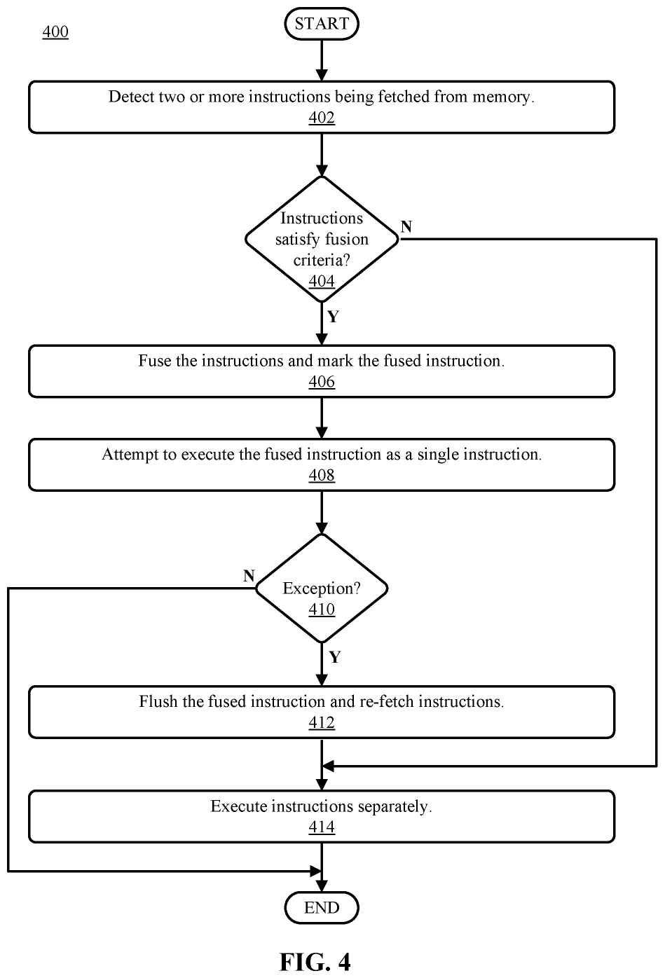

Referring now to FIG. 4, illustrated is a flowchart of an example method 400 for fusing store instructions in a microprocessor, in accordance with embodiments of the present disclosure. The method 400 may be performed by hardware, firmware, software executing on a processor, or any combination thereof. The method 400 may begin at operation 402, wherein two or more instructions are detected.

The two or more instructions may be detected by an IFU when they are being fetched from memory (e.g., from an L2 cache) for execution. After detecting the two or more instructions, the IFU may determine whether the instructions satisfy a set of fusion criteria at decision block 404. As discussed herein, the set of fusion criteria are a set of rules that determine whether the instructions can be fused. The set of fusion criteria may be based on the architecture of the processor (e.g., how the hardware units are configured). The set of fusion criteria may include whether the instructions are near each other in the fetch queue (e.g., consecutive instructions, only 1 instruction between them, etc.), whether the instructions have the same base register, the offset of the instructions, and the type of instruction (e.g., D-form store vs. X-form store).

If the instructions do not satisfy the set of fusion criteria, the instructions may be executed separately at operation 414, and the method 400 may end. However, if the instructions do satisfy the set of fusion criteria, the instructions may be fused at operation 406. Additionally, the instructions may be marked (e.g., by the IFU) to indicate that they are fused, and whether the instructions are in order or need to be flipped.

At operation 408, the processor attempts to execute the fused instruction as a single instruction, as described herein. If there is no exception at decision block 410, the store instruction completes and the fused instruction is executed. However, if an exception is identified at decision block 410, the fused instruction is flushed, and the instructions that were fused are re-fetched. The re-fetched instructions are then executed separately (e.g., normally), and the method 400 ends.

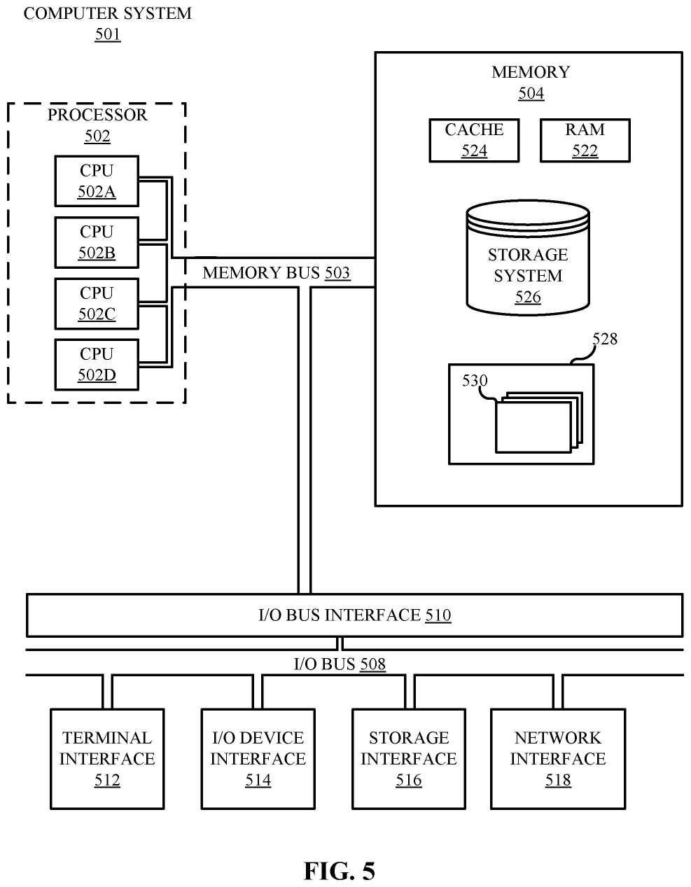

Referring now to FIG. 5, shown is a high-level block diagram of an example computer system 501 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 501 may comprise one or more CPUs 502, a memory subsystem 504, a terminal interface 512, a storage interface 516, an I/O (Input/Output) device interface 514, and a network interface 518, all of which may be communicatively coupled, directly or indirectly, for inter-component communication via a memory bus 503, an I/O bus 508, and an I/O bus interface unit 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache.

System memory 504 may include computer system readable media in the form of volatile memory, such as random access memory (RAM) 522 or cache memory 524. Computer system 501 may further include other removable/non-removable, volatile/non-volatile computer system storage media. By way of example only, storage system 526 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 504 can include flash memory, e.g., a flash memory stick drive or a flash drive. Memory devices can be connected to memory bus 503 by one or more data media interfaces. The memory 504 may include at least one program product having a set (e.g., at least one) of program modules that are configured to carry out the functions of various embodiments.

One or more programs/utilities 528, each having at least one set of program modules 530 may be stored in memory 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Program modules 530 generally perform the functions or methodologies of various embodiments.

Although the memory bus 503 is shown in FIG. 5 as a single bus structure providing a direct communication path among the CPUs 502, the memory subsystem 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single respective units, the computer system 501 may, in some embodiments, contain multiple I/O bus interface units 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary. Furthermore, the modules are listed and described illustratively according to an embodiment and are not meant to indicate necessity of a particular module or exclusivity of other potential modules (or functions/purposes as applied to a specific module).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that the aforementioned advantages are example advantages and should not be construed as limiting. Embodiments of the present disclosure can contain all, some, or none of the aforementioned advantages while remaining within the spirit and scope of the present disclosure.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications, alterations, and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s). Additionally, it is intended that the following claim(s) be interpreted as covering all such alterations and modifications as fall within the true spirit and scope of the invention.

1. A method comprising:
identifying two instructions in an execution pipeline of a microprocessor, wherein the two instructions include a first instruction and a second instruction;
determining that the two instructions meet a fusion criteria, wherein determining that the two instructions meet the fusion criteria comprises determining that the first and second instructions have a same instruction form and store data in contiguous memory locations;
recoding, in response to determining that the two instructions meet the fusion criteria, the two instructions into a fused instruction; and
executing the fused instruction.

2. The method of claim 1, wherein determining that the two instructions meet the fusion criteria further comprises:
determining that the first and second instructions have a same instruction type, a same instruction length, and that they are consecutive instructions in a fetch queue.

3. The method of claim 1, wherein the method further comprises:
identifying an exception while executing the fused instruction;
flushing the fused instruction; and
re-fetching the two instructions.

4. The method of claim 3, wherein the method further comprises:
executing, after re-fetching the two instructions, the two instructions separately.

5. The method of claim 3, the method further comprising:
determining that the exception was related to the first instruction of the two instructions; and
recording the exception against the first instruction.

6. The method of claim 1, wherein the first instruction was fetched before the second instruction, the method further comprising:
determining that the first instruction is to store data to a first area of memory;
determining that the second instruction is to store data to a second area of memory that directly precedes the first area of memory;
marking the fused instruction as reversed; and
flipping an order of the first and second instructions in the fused instruction.

7. The method of claim 1, wherein the first and second instructions are D-form store instructions, and wherein determining that the two instructions meet the fusion criteria further comprises:
determining that the first and second store instructions have the same base register;
determining a store length for the first and second instructions, wherein the store length is the same for both the first and second instructions; and
determining that a difference between a first offset of the first instruction and a second offset of the second instruction is equal to the store length.

8. A system comprising:
a processor configured to perform a method comprising:
identifying two instructions in an execution pipeline of the processor, wherein the two instructions include a first instruction and a second instruction;
determining that the two instructions meet a fusion criteria, wherein determining that the two instructions meet the fusion criteria comprises determining that the first and second instructions have a same instruction form and store data in contiguous memory locations;
recoding, in response to determining that the two instructions meet the fusion criteria, the two instructions into a fused instruction; and
executing the fused instruction.

9. The system of claim 8, wherein determining that the two instructions meet the fusion criteria further comprises:
determining that the first and second instructions have a same instruction type, a same instruction length, and that they are consecutive instructions in a fetch queue.

10. The system of claim 8, wherein the method further comprises:
identifying an exception while executing the fused instruction;
flushing the fused instruction; and
re-fetching the two instructions.

11. The system of claim 10, wherein the method further comprises:
executing, after re-fetching the two instructions, the two instructions separately.

12. The system of claim 10, the method further comprising:
determining that the exception was related to the first instruction; and
recording the exception against the first instruction.

13. The system of claim 8, wherein the first instruction precedes the second instruction in a fetch queue, the method further comprising:
determining that the first instruction is to store data to a first area of memory;
determining that the second instruction is to store data to a second area of memory that directly precedes the first area of memory;
marking the fused instruction as reversed; and
flipping an order of the first and second instructions in the fused instruction.

14. The system of claim 8, wherein the first and second instructions are D-form store instructions, and wherein determining that the two instructions meet the fusion criteria further comprises:
determining that the first and second instructions have the same base register;
determining a store length for the first and second instructions, wherein the store length is the same for both the first and second instructions; and
determining that a difference between a first offset of the first instruction and a second offset of the second instruction is equal to the store length.

15. A processor comprising:
an instruction fetch unit configured to:
determine that two store instructions fetched from memory are fusible by determining that the two store instructions have a same instruction form, store data in contiguous memory locations, and are consecutive in a fetch queue; and
recode the two store instructions into a fused store instruction;
an instruction sequencing unit configured to:
receive the fused store instruction from the instruction fetch unit; and
store the fused store instruction as an entry in an issue queue, wherein a first half of the fused store instruction is stored to a first half of the issue queue, and a second half of the fused store instruction is stored to a second half of the issue queue; and
a load-store unit configured to:
receive the fused store instruction from the issue queue via a vector/scalar unit;
generate a store address using the first half of the fused store instruction;
store the store address in a store reorder queue; and
store data identified by the second half of the fused store instruction in a store data queue.

16. The processor of claim 15, wherein the load-store unit is further configured to:
identify an exception while executing the fused store instruction;
flush the fused store instruction; and
instruct the instruction fetch unit to re-fetch the two store instructions.

17. The processor of claim 16, wherein the processor is further configured to:
execute, after re-fetching the two store instructions, the two store instructions as separate instructions.

18. The processor of claim 15, wherein the two store instructions include a first store instruction and a second store instruction, and wherein determining that the two store instructions are fusible further comprises:
determining that the first and second store instructions have a same instruction type and a same instruction length.

19. The processor of claim 15, wherein the two store instructions include a first store instruction that was fetched before a second store instruction, and wherein the instruction fetch unit is further configured to:
determine that the first store instruction is configured to store data to a first area of memory;
determine that the second store instruction is configured to store data to a second area of memory that directly precedes the first area of memory; and
mark the fused store instruction as reversed.

20. The processor of claim 19, wherein the instruction sequencing unit is further configured to:
flip an order of the first and second store instructions in the fused store instruction in response to identifying that the fused store instruction is marked as reversed.
